(19) United States
(12) Patent Application Publication
(10) Pub. No.: US 2009/0037956 A1
(43) Pub. Date: Feb. 5, 2009

(54) METHODS AND APPARATUS FOR ONE TOUCH FIND AND RECORD

(75) Inventors: Eric J. Bennett, Los Angeles, CA (US); David P. Green, Castaic, CA (US); Tommi Iten, Redondo Beach, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 11/830,755

(22) Filed: Jul. 30, 2007

(51) Int. Cl. H04N 5/445

(52) U.S. Cl. 725/44

(57) ABSTRACT

Methods and apparatus of finding related programs in a media presentation program are described. An example method includes displaying a current program associated with a program data of the media presentation program, receiving an input from an interface, searching the program data in response to the input, and displaying a search results in the media presentation program.

### FIELD OF THE DISCLOSURE

The present invention relates generally to the digital recording and playback of recorded audiovisual signals. More particularly, it relates to methods and apparatus for one touch find and record.

### BACKGROUND

The emergence of digital broadcasting systems has given rise to Digital Video Recording (DVR) devices, which allow consumers to record and store a digital copy of programming content. A DVR device gives users the ability to replay a recording more efficiently than its analog predecessors (e.g., VCRs). Digital broadcasting typically includes transmission of program guide data that is received by a device (e.g., a DVR, a set top box, etc.) capable of displaying a program guide. Conventionally, to record an audiovisual program associated with the program guide, a user browses the program guide for individual programs and flags each individual program that the user desires to be recorded.

### BRIEF DESCRIPTION OF THE DRAWINGS

FIG. 1 is a diagram of an example direct-to-home (DTH) transmission and reception system.

FIG. 2 is a high level view of an example apparatus capable of receiving, recording, and playing audiovisual data.

FIG. 3 is a diagram representing an example user interface screen arrangement to carry out one touch find and record functionality.

FIG. 4 is an illustration of an example record options interface of the example process of FIG. 3.

FIG. 5 is an illustration of an edit name interface of example process of FIG. 3.

FIG. 6 is an illustration of an edit category interface of the example process of FIG. 3.

FIG. 7 is an illustration of another edit category interface of the example process of FIG. 3.

FIG. 8 is an illustration of an example search results interface of the example process of FIG. 3.

FIG. 9 is an illustration of an example confirmation interface the example process of FIG. 3.

FIG. 10 is an illustration of an example single results interface of the example process of FIG. 3.

FIG. 11 is a diagram representing an example user interface screen arrangement to carry out one touch find and autotune.

### DETAILED DESCRIPTION

Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

The example methods, apparatus and articles of manufacture described herein may be used to enable a user of a digital video recorder (DVR) to configure the DVR to automatically record media presentations (e.g., programs) related to a current program (e.g., the current program). This configuration may be carried out using any suitable user interface such as a remote interface and/or user input keys on a set top box. The current program may be a currently displayed program (i.e., the program to which the user is tuned) and/or a program having information selected in a program guide including program information selected (e.g., title, actor, category, etc.). For example, a current program may be a program selected from a search results, a program selected from a program listing, or any other program information selected in the program guide. In addition, the current program may be selected information associated with a program of the program guide (e.g., time, channel, category, etc.). Additionally, the example methods, apparatus, and articles of manufacture may be used to enable a user of a DVR or set top box to automatically tune into programs related to the current program.

In one example, to configure the DVR to record programs related to a current program, the user sends a code to the DVR using a remote interface (e.g., a remote control, a keyboard, a mouse, etc.) or a local interface (e.g., a button on the DVR or set top box). In response to the code, the DVR uses information associated with the current program and executes the example methods, apparatus, and computer readable mediums described herein to automatically flag audiovisual programs for recording. However, the example methods may be used as a supplement to existing methods of recording and/or tuning via a DVR or a set top box (i.e., the examples described herein supplement, but do not necessarily replace existing methods).

The example methods, apparatus and articles of manufacture described herein are described in operation with a satellite broadcast system. However, such examples are not restrictive. For example, the example methods, apparatus and articles of manufacture described herein may be used with any interface (e.g., a remote interface, a local interface, etc.) and equipment with which the interface operates or is intended to operate, regardless of how the system in which the interface is used is configured or the system in which it was used.

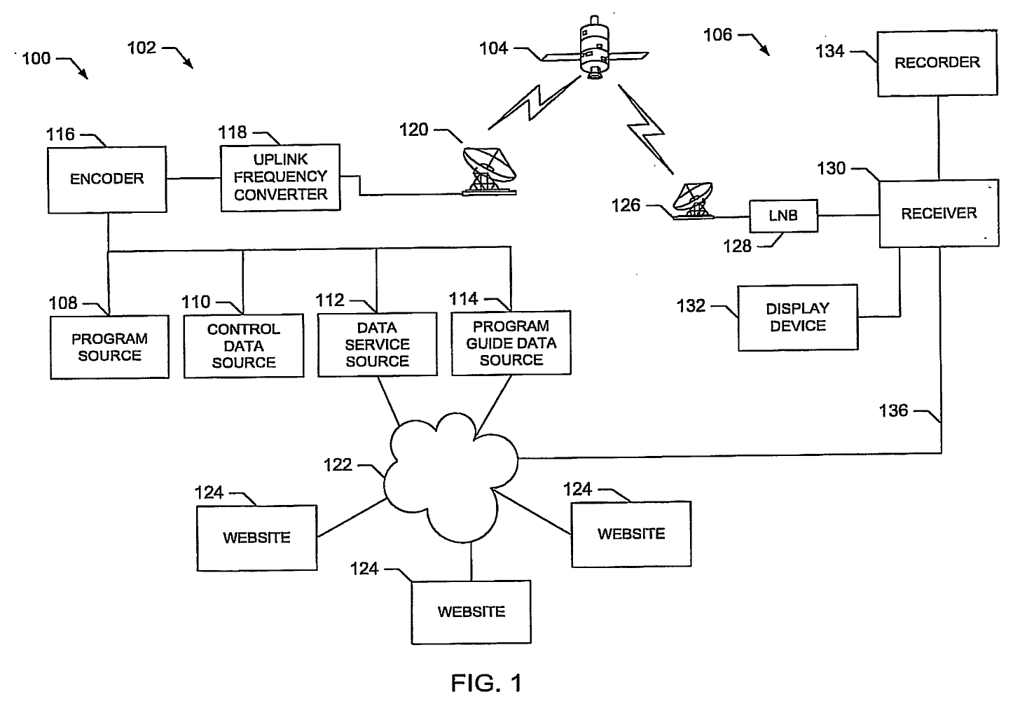

As illustrated in FIG. 1, an example direct-to-home (DTH) system 100 generally includes a transmission station 102, a satellite/relay 104 and a plurality of receiver stations, one of which is shown at reference numeral 106, between which wireless communications are exchanged. The wireless communications may take place at any suitable frequency, such as, for example, Ku-band frequencies. As described in detail below with respect to each portion of the system 100, information from the transmission station 102 is transmitted to the satellite/relay 104, which may be at least one geosynchronous or geo-stationary satellite that, in turn, rebroadcasts the information over broad geographical areas on the earth that include receiver stations 106. To facilitate backchannel communications, the receiver stations 106 may be communicatively coupled to the transmission station 102 via a terrestrial communication link, such as a telephone line and/or an Internet connection 136.

In further detail, the example transmission station 102 of the example system of FIG. 1 includes a plurality of sources of data and/or information (e.g., program sources 108, a control data source 110, a data service source 112, and one or more program guide data sources 114). During operation, information from one or more of these sources 108-114 passes to an encoder 116, which encodes the information for broadcast to the satellite/relay 104. Encoding includes, for example, converting the information into data streams that are multiplexed into a packetized data stream or bitstream using any of a variety of algorithms. A header is attached to each data packet within the packetized data stream to facilitate identification of the contents of the data packet. The header also includes a service channel identifier (SCID) that identifies the data packet. This data packet is then encrypted. As will be readily appreciated by those having ordinary skill in the art, a SCID is one particular example of a program identifier (PID).

To facilitate the broadcast of information, the encoded information passes from the encoder 116 to an uplink frequency converter 118 that modulates a carrier wave with the encoded information and passes the modulated carrier wave to an uplink antenna 120, which broadcasts the information to the satellite/relay 104. Using any of a variety of techniques, the encoded bitstream is modulated and sent through the uplink frequency converter 118, which converts the modulated encoded bitstream to a frequency band suitable for reception by the satellite/relay 104. The modulated, encoded bitstream is then routed from the uplink frequency converter 118 to the uplink antenna 120 where it is broadcast toward the satellite/relay 104.

The programming sources 108 receive video and audio programming from a number of sources, including satellites, terrestrial fiber optics, cable, and/or tape. The video and audio programming may include, but is not limited to, television programming, movies, sporting events, news, music, Internet content, any media, and/or any other desirable content.

Like the programming sources 108, the control data source 110 passes control data to the encoder 116. Control data may include data representative of a list of SCIDs to be used during the encoding process, or any other suitable information.

The data service source 112 receives data service information and web pages made up of text files, graphics, audio, video, software, etc. Such information may be provided via a network 122. In practice, the network 122 may be the Internet, a local area network (LAN), a wide area network (WAN) or a conventional public switched telephone network (PSTN). The information received from various sources is compiled by the data service source 112 and provided to the encoder 116. For example, the data service source 112 may request and receive information from one or more websites 124. The information from the websites 124 may be related to the program information provided to the encoder 116 by the program sources 108, thereby providing additional data related to programming content that may be displayed to a user at the receiver station 106.

The program guide data source 114 compiles information related to the SCIDs used by the encoder 116 to encode the data that is broadcast. For example, the program guide data source 114 includes information that the receiver stations 106 use to generate and display a program guide to a person (i.e., a user), wherein the program guide may be a grid guide that informs the user of particular programs that are available on particular channels at particular times. The program guide also includes information that the receiver stations 106 use to assemble programming for display to the user. For example, if the user desires to watch a baseball game on his or her receiver station 106, the user will tune to a channel on which the game is offered. As described in detail below, the receiver station 106 gathers the SCIDs related to the game, wherein the program guide data source 114 has previously provided to the receiver station 106 a list of SCIDs that correspond to the game.

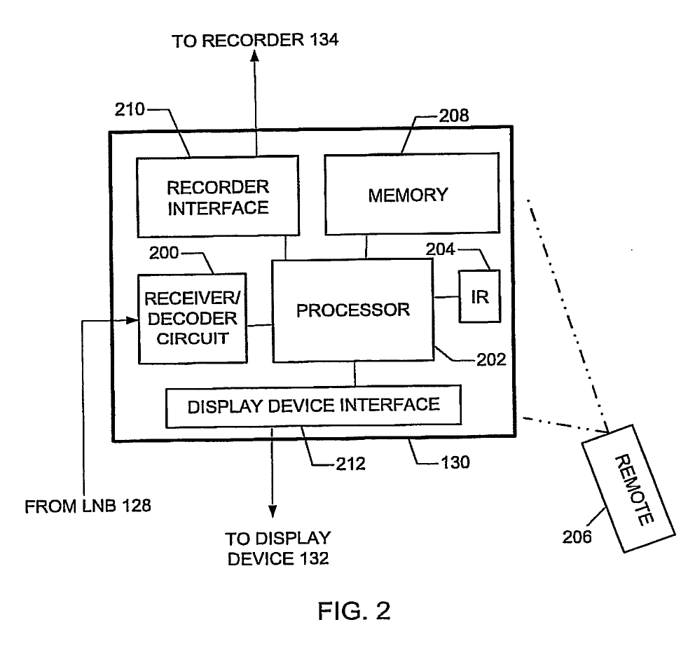

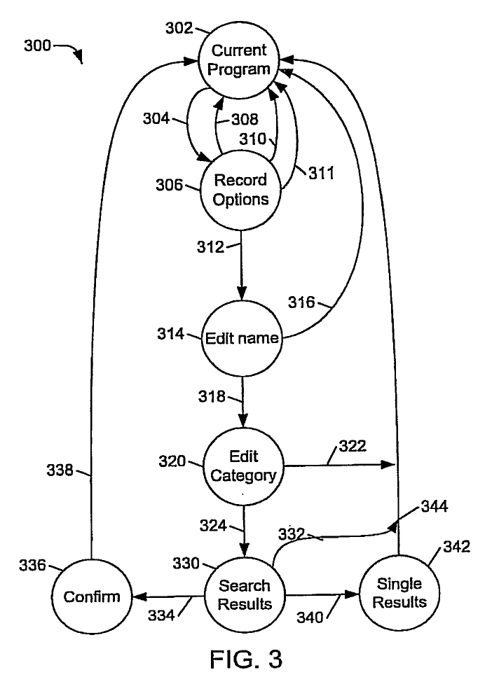

The satellite/relay 104 receives the modulated, encoded Ku-band bitstream and re-broadcasts it downward toward an area on earth that includes the receiver station 106. In the illustrated example of FIG. 1, the example receiver station 106 includes a reception antenna 126 connected to a low-noise-block (LNB) 128 that is further connected to a receiver 130. As described in conjunction with FIGS. 2 and 3 below, the receiver 130 may be a set-top box or may be a personal computer (PC) having a receiver card installed therein. A display device 132, such as, for example, a television set or a computer monitor, is coupled to the receiver 130 for displaying received programming to a user. Additionally, the example receiver station 106 may include a recorder 134 used to record programming received by the receiver station 106. The recorder 134 may be, for example, a device capable of recording information on media, such as videotape or digital media such as a hard disk drive, a DVD, a compact disk (CD) and/or any other suitable media.

Although not necessary for proper operation of the example system of FIG. 1, the receiver station 106 may optionally incorporate a connection 136 (e.g., Ethernet circuit or modem for communicating over the Internet) to the network 122 for transmitting requests and other data back to the transmission station 102 (or a device managing the transmission station 102 and overall flow of data in the example system 100) and for communicating with websites 124 to obtain information therefrom.

In operation of the receiver station 106, the reception antenna 126 receives signals including a bitstream from the satellite 104. The signals are coupled from the reception antenna 126 to the LNB 128, which amplifies and, optionally, downconverts the received signals. The LNB output is then provided to the receiver 130, which, as described in detail below, receives, depacketizes, demultiplexes and decodes the received signal to provide audio and video signals to the display device 132 and/or the recorder 134. The receiver 130 is responsive to user inputs to tune to a particular program, by selecting and decoding a particular frequency and the particular SCIDs on which the desired program is located.

FIG. 2 depicts the receiver 130 of FIG. 1 in more detail. Specifically, the receiver 130 includes front-end circuitry 200 in the form of a receiver/decoder circuit, a processor 202, an entry device 204, a memory 208, a recorder interface 210, and a display device interface 212. Further, the receiver 130 may be operated remotely by a remote interface 206.

In general, the front-end circuitry 200 inside the receiver 130 receives the L-band Radio Frequency (RF) signals from the LNB 128 and converts the signals back into the original digital data stream. The decoding circuitry 200 receives the original data stream and performs video/audio processing operations such as demultiplexing and decompression.

The processor, microprocessor or central processing unit (CPU) 202 controls the overall operation of the receiver 130, including the selection of parameters, the set-up and control of components, channel selection, and many other functions. For example, the processor 202 controls the recording of audiovisual program and the playback of recorded audiovisual programs. In another example, the processor 202 searches program data of a program guide, queues at least one program associated with the program guide to be recorded, and records any program in the queue (while the program is being broadcast).

The entry device 204 is the port for communication between the receiver, or set-top box, 130 and the remote interface 206. The entry device 204 may be, for example, an IR and/or RF detector adapted to receive communications from the remote interface 206. The entry device 204 senses the operation of the remote interface 206 and relays the signals from the remote interface 206 to the processor 202.

The memory 208 that is connected to the processor 202 is used to store information such as, for example, instructions for operation of the processor 202 to perform the processes described herein, tables of programmed special codes for use in the processes, and other proprietary software designed to recognize codes associated with the remote interface. The type, size and proportion of the memory illustrated in the example receiver 130 may vary.

The example receiver 130 also includes a plurality of interfaces such as, for example the recorder interface 210 and the display device interface 212. The interfaces 210, 212 may be used to provide connectivity to one or more peripherals, for example a recorder 134 or a display device 132.

Although the example receiver 130 is shown as having a plurality of components that are interconnected or communicatively coupled with other components, such interconnections are illustrated by way of example and should not be construed as limiting the manner in which the components can be interconnected to the example methods, apparatus, and/or systems described herein. On the contrary, the devices described above in connection with the receiver 130 may be interconnected in any other suitable manner to implement the example methods, apparatus, and/or systems.

FIG. 3 illustrates an example process 300 to automatically record programs associated with the program guide. Additionally, the example process 300 may also be used to automatically tune the receiver 130 into a related program. As described above, the program guide data source 114 includes information that the receiver 130 may use to generate and display a program guide. Initially, a current program is displayed to the user (block 302). In some examples, the current program may be a broadcast audiovisual program (e.g., a movie, a television show, etc.) or a recorded program stored in the DVR. Additionally, the current program may be selected information of a program in the program guide. In some examples, the user may send a first code to the example apparatus by engaging a button on the remote interface 206 (e.g., the record button). If the user continues to engage the button for at least a predetermined time period (e.g., two seconds), the remote interface 206 may send a second code. Additionally, the receiver 130 may understand that a code sent from the remote interface 206 for at least a predetermined period of time (e.g., 2 seconds) is a second code.

In response to the second code, the example process 300 searches the program guide data based on search parameters associated with the current program and returns a set of search results. The search parameters are based on information of the program guide data associated with the current program. In some examples, the example process 300 may search the program guide data based on a category associated with the current program (e.g., the first listed category in the program guide data) and a name associated with the current program (e.g., the first listed name in the program guide data). Additionally, the search parameters may be based on a selected field in the program guide. For example, if the category field of a current program in the program guide is selected, the search parameters may be the first category and the second category of the current program. In other examples, the search parameters may be based on settings of the user (i.e., the user has manually configured the search parameters). Additionally and/or alternatively, the search history of the user may also be used to search the program guide data. For example, the example process 300 may associate a second category with the search parameters if a user frequently searches for the second category. The search history of the user may also be used to sort the search results before presenting the results to the user.

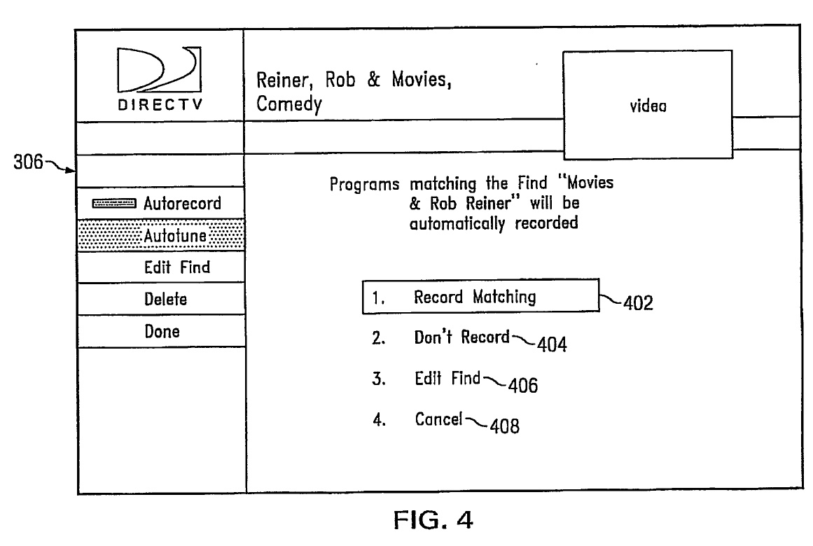

After the search is completed, a record options interface is created and presented to the user (block 306). In some examples, the record options interface may present options for the user as illustrated in FIG. 4. In the example of FIG. 4, four options are presented to the user, which includes a record matching option 402, a don't record option 404, an edit find option 406, and a cancel option 408. By selecting the record matching option 402, the example process 300 configures the receiver 130 to automatically record the matching programs (i.e., the search results) based on the user's default record settings (e.g., episode type, keep at most, keep until, start, stop, etc.), clear the on-screen display, and return to the current program (path 308). If the user selects the don't record option 404, the example process 300 stores the search parameters in the search history, clears the on-screen display, and returns to the current program (path 310). If the user selects the cancel option 408, the example process 300 clears the on-screen display and returns to the current program (path 311). However, if the user selects the edit find option 406, the example process 300 stores the search parameters in the search history (path 312) and presents the edit name screen to the user (block 314).

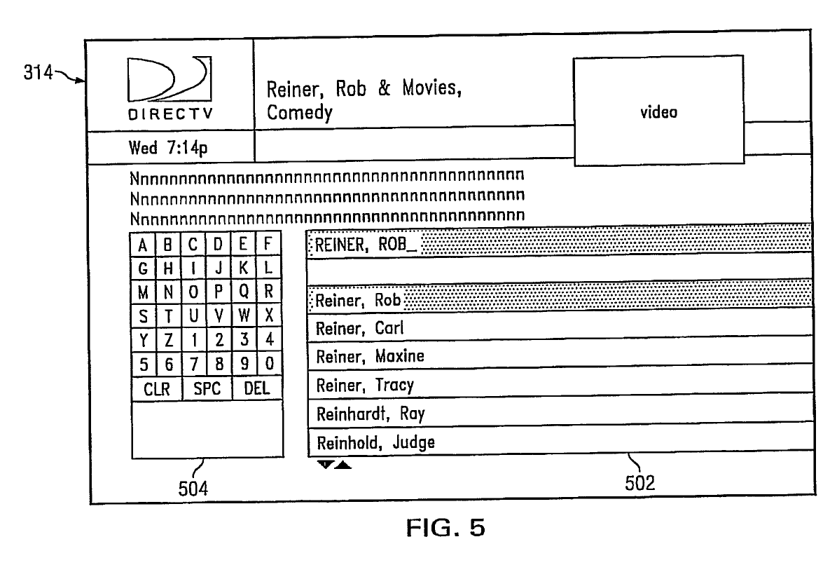

In some examples, the edit find option 406 may allow a user to manually edit the search parameters based on information associated with the current program (e.g., a name, a category, etc.). For instance, FIG. 5 illustrates an example edit name screen to allow the user to select a different search name associated with the current program. Using the list of all names (block 502) associated with the selected program (e.g., actors, directors, writers, producers, etc.), the user may select a new name to search the program guide with. As illustrated in FIG. 5, the list of names may also be associated with all of the names in the program guide. Optionally, the user may manually enter a new name via an on-screen keypad (block 504). Using the remote interface 206, the user may also cancel the operation to clear the on-screen display and return to the current program (path 316). But if the user selects a new name, the new name is stored in the as a search parameter (path 318) and the example process 300 displays the edit category screen (block 320).

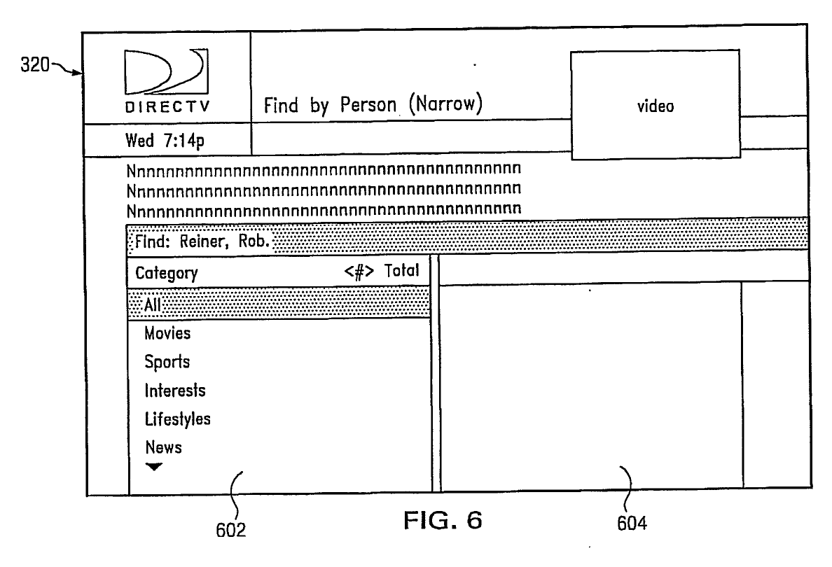

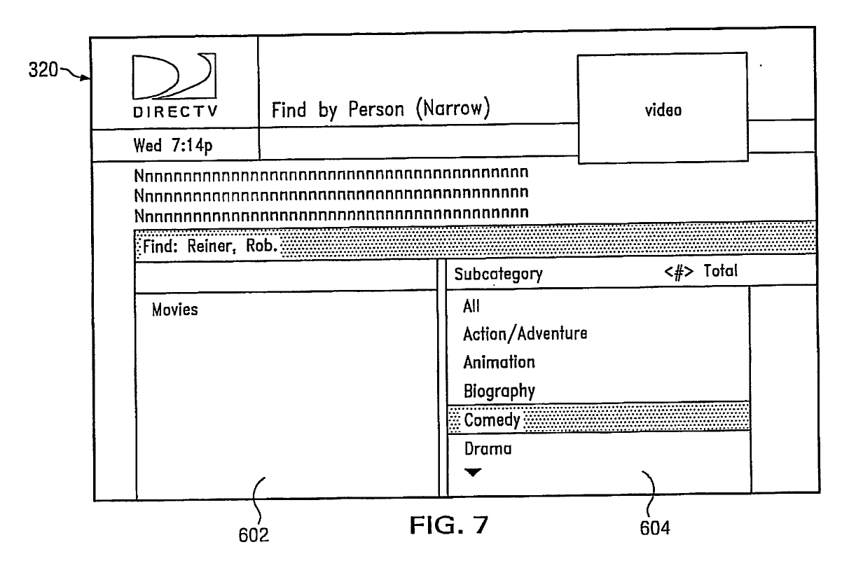

FIG. 6 is an illustration of an example edit category screen that allows the user to select a different program category as a search parameter via the category box (block 602). The program category may consist of any suitable video programming available to the user (i.e., movies, documentaries, news, sports, etc.). As illustrated in FIG. 7A, after selecting a category, the subcategory box (block 604) is populated with subcategories of the selected category. Using the remote interface 206, the user may also cancel the operation to clear the on-screen display and return to the current program (path 322). But if the user selects a new category and subcategory, the category and subcategory are stored as search parameters and the example process 300 searches the program guide data based on the search parameters the user selected (path 324).

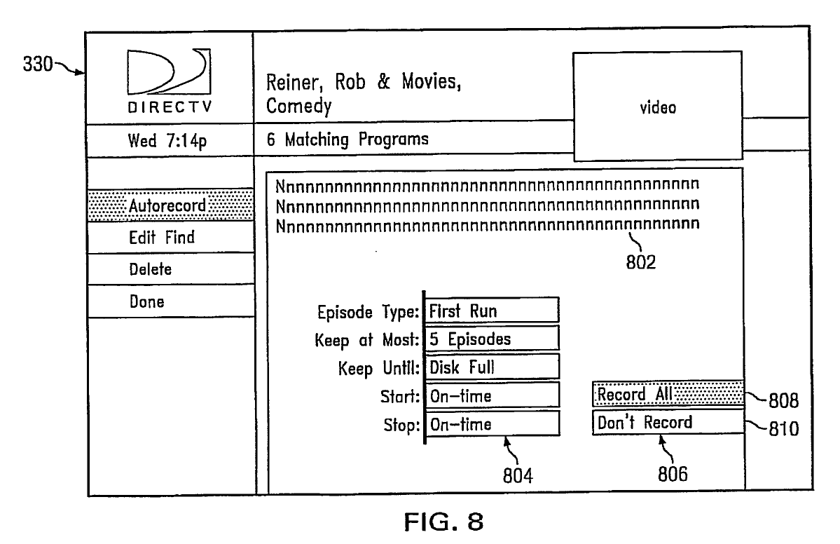

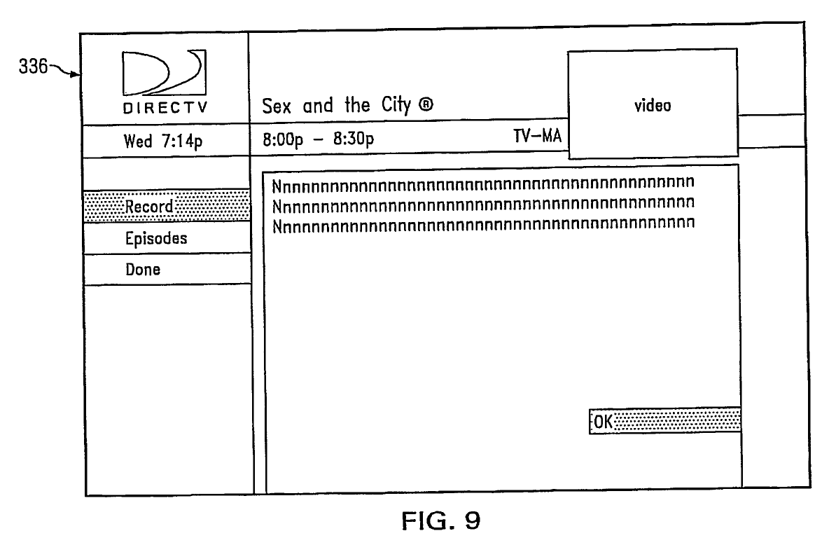

After modifying the search parameters and searching the program guide data, the search results interface (block 330) including program recording options are presented to the user. In the example of FIG. 8, the search results interface includes the search results (block 802), the recording settings (block 804), and the record options (block 806). The user may select either the record all option 808 or the don't record option 810 via the record options. Using the remote interface 206, the user may also cancel the operation to clear the on-screen display and return to the current program (path 332). But, if the user selects the record all option, the example process 300 saves the search results (path 334) and presents a confirmation screen to the user (block 336). FIG. 9 illustrates an example of illustration of a confirmation screen where the user can confirm the recording of the search results. When the user confirms the programs to be recorded, the example process 300 configures the example apparatus to automatically record the matching programs (path 328), clears the on-screen display, and returns to the current program.

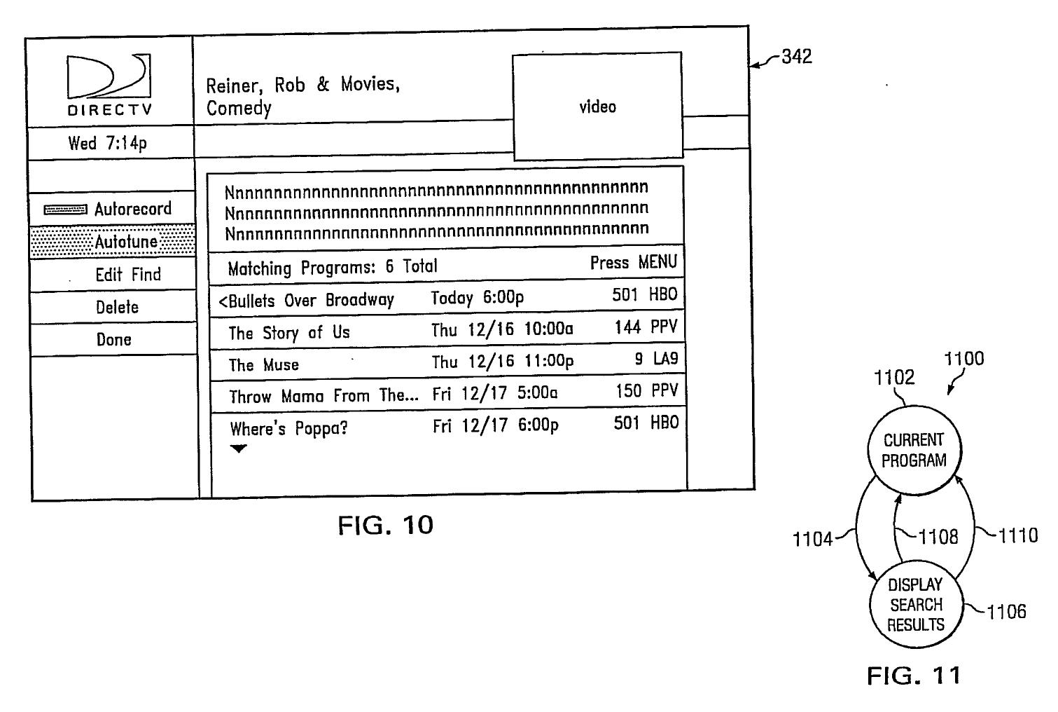

However, if the user selects the don't record option 810, the example process 300 saves the search results (path 340) and presents the user with a single result list (block 342). FIG. 10 is an illustration of the single results list that shows the search results in a grid format. In the example of FIG. 10, the user may manually select and record individual programs via the remote 206. When the user is finished, the user may use the remote to clear the on-screen display and return to the current program (path 344).

FIG. 11 illustrates another example process 1100 to automatically tune a DVR or set top box to programs associated with the current program. Initially, the user begins at current program (block 1102). Similar to the example process of FIG. 3, the user engages a button on the remote interface 206 for a predetermined period of time to send a code to the DVR or set top box. In response to the command, the example process 1100 searches the program guide data based on information associated with the current program (i.e., the program highlighted in the program guide or the program currently being watched) (path 1104). The search results are displayed in an on-screen display (block 1106).

Using the search results, a user may cancel and return to the current program (path 1106) or may choose to automatically tune to a program in the search results (path 1108). If the user chooses to automatically tune into the program associated with the search result, the DVR or set top box automatically tunes into the selected program from the current program and clears the on-screen display (path 1110). In other words, if the user selects a new program in the search results, the example process 1100 makes the newly selected program the current program.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of finding related programs in a media presentation program, comprising:
displaying a current program associated with a program data of the media presentation program;
receiving an input from an interface, wherein an interface button is engaged for at least a predetermined period of time;
searching the program data in response to the input, wherein the search is based on an information associated with the current program; and
displaying a search result in the media presentation program.

2. A method as defined in claim 1, wherein the interface is a remote interface.

3. A method as defined in claim 1, wherein the current program is an audiovisual program associated with the program data.

4. A method as defined in claim 2, wherein the current program is a recorded program of the media presentation program.

5. A method as defined in claim 2, wherein the current program is a real-time program.

6. A method as defined in claim 1, wherein the current program is a selected information of an audiovisual program in the media presentation program.

7. A method as defined in claim 4, wherein the search is based on the selected information of the audio visual program in the media presentation program.

8. A method as defined in claim 1, further comprising configuring the media presentation program to record at least one program associated with the search results in response to a second input.

9. A method as defined in claim 1, further comprising configuring the media presentation program to display a program associated with the search results in response to a second input.

10. A method as defined in claim 1, wherein the information associated with the current program to be used in the search is programmed by a user.

11. A method as defined in claim 1, wherein searching the program data based on information associated with the current program is further based on a search history.

12. A method as defined in claim 1, wherein the search results further comprises sorting the search results based on a search history.

13. A method as defined in claim 1, wherein the input from the interface sends a first command and sends a second command in response to engaging the button for the predetermined period of time.

14. An apparatus comprising:
a communications device adapted to receive a program data via a communication link; and
a processor coupled to the communications device to generate a video output signal on a display device, wherein, in response to a command from an interface, the processor is to search a program data based on an information associated with a current program and display a search results on the display device.

15. An apparatus as defined in claim 12, wherein the interface is a remote interface.

16. An apparatus as defined in claim 12, wherein the current program is an audiovisual program associated with the program data.

17. An apparatus as defined in claim 12, wherein the current program is a selected information of an audiovisual program in the media presentation program.

18. An apparatus as defined in claim 12, wherein the processor displays a video program in response to a second command.

19. An apparatus as defined in claim 12, further comprising a storage device capable of recording a program.

20. An apparatus as defined in claim 17, wherein the storage device is configured to record at least one program in the search results.

21. An apparatus as defined in claim 12, wherein the input is to be provided via a remote device coupled to the apparatus.

22. An apparatus as defined in claim 19, wherein the input is pressing and holding the button down on an interface at least a predetermined period of time.

23. A computer readable medium having instructions stored thereon that, when executed, cause a machine to:
search a program data of a media presentation program, wherein the search is based on an information associated with a current program; and
display a search results.

24. A computer readable medium as defined in claim 21, wherein a remote device is to execute the computer readable medium.

25. A computer readable medium as defined in claim 21, wherein the current program is a audiovisual program associated with the program data.

26. A computer readable medium as defined in claim 21, wherein the current program is a selected audiovisual program in a media presentation program.
